(19) United States
(12) Patent Application Publication
(10) Pub. No.: US 2007/0131667 A1
(43) Pub. Date: Jun. 14, 2007

(54) Food container product

(76) Inventor: Daniel M. Amato, Wellington, FL (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/301,332

(22) Filed: Dec. 12, 2005

(51) Int. Cl. A21B 1/52

(52) U.S. Cl. 219/387

(57) ABSTRACT

The present invention provides novel food containment devices comprising an insulating layer sandwiched between layers of construction materials, and which optionally includes a plurality of convection openings to emit moisture vapor or humidity emanating from a hot food product within the container.

### COPYRIGHT NOTICE

Copyright 2005 Daniel K. Amato, et al. All rights reserved. A portion of the disclosure of this patent application/patent document contains material which is subject to copyright protection. The copyright owner has no objection to the facsimile reproduction by anyone of this document, or patent which issues therefrom as it appears in the U.S. Patent and Trademark Office files and records.

### FIELD OF THE INVENTION

The present invention relates to food containers, and more particularly to improved food containers having superior insulation properties, breathability and moisture release properties, and which are especially suited for use with hot and chilled fast food, carry-out, and delivery food products and services.

### BACKGROUND OF THE INVENTION

The ever-increasing take-out, fast food and prepared food delivery service industry has spawned unheralded restaurant chain and fast food franchise development and growth in the food services industry in recent years. This growth is thought by many to be partly due to changing lifestyles, work and leisure time habits in the United States and other developed countries, with no end to the booming growth in sight. To accommodate these rapidly expanding industries, ancillary growth industries have emerged with an important one being the proper transport of prepared and/or perishable foodstuffs and products, such as pizza and other fast food products, to ensure food quality on arrival. A pivotal part of this industry is the quality and efficiency of the oftentimes discardable containers that such prepared and/or fast food is transported in, with many new variations making their appearance as the fast food industry continues its dramatic growth. However, despite advances in product packaging, much, if not all, of conventional food product transport packaging continues to needlessly destroy food quality due to various design flaws, which often results in soggy, unappealing food products on arrival.

In one example to remedy failings of conventional food transport product containers, U.S. Patent Application Publication No. U.S. 2005/0115944 discloses a lightweight, disposable and sealable food transport container for pizza and the like, which employs radiant and convection barriers which are an integral reflective material and an airtight heat transfer retarding material, respectively. Some of these food containers are also provided with a vent opposite an opening to the container to allow the escape of moist vapor from the container emanating from heated food items. The containers are generally in the familiar shape of a pizza box with a hinged lid and are made of cardboard, with lid and bottom portions and oppositely opposed lateral side walls integral with a bottom portion, and lateral side walls integral with a front portion attached to the lid. The radiant barrier, a reflection/insulation material, such as a thin sheet of aluminum, or a metalized polymer, e.g., metalized oriented polyethylene, is attached to an inside or outside portion of the rectangular top section or lid to reflect heat from an enclosed food product, e.g., a pizza, back to the product. Also described in other variations is a reflective radiant barrier integrated into the container, containers formed from metalized cardboard, and containers in which a radiant barrier is applied to the entire inside or outside portion of a food container.

As may be seen, however, the use of a reflective radiant barrier directly facing a heated food product will achieve a tendency to create an undesirable reflux atmosphere with moist vapors being forced by convection from the reflective surface back to form condensation on the heated food product. Vapors may condense on the metal surface itself and then fall back on the heated food product as water droplets. Such vaporizing and condensing activities continue with condensation forming repeatedly on the food product in cycles. Even with a vent opening, a certain amount of reflux activity is certain to occur in the presence of such a reflective surface. The end result becomes a soggy, tasteless product that may have once been a quality product.

In another example, U.S. Pat. No. 5,454,471 describes a food product container fabricated of breathable material which is permeable to water vapor and repellant to liquid. Soggy food is said to be avoided with water vapor dissipating away from enclosed food products. Materials employed for moisture vapor permeable and liquid repellant liners are described as micro-porous lattice-containing polytetrafluoroethylene (PTFE), such as provided from W.L. Gore & Associates, Inc., under the Gore-Tex brand, an expanded PTFE membrane. These products, however, can hardly be said to be economical, and are not bio-degradable.

U.S. Pat. No. 5,300,333 describes a throw-away bio-degradable insulation food container constructed from a multiplicity of expandable grains that have been expanded or popped and bound together by a bonding agent. These grains can be whole heat-expanded grains or ground heat-expanded grains, such as popcorn and rice, with the bonding agent being a FDA approved food grade paste comprising mixtures of compounds of dextrose, starches, starch paste, borated starch paste, borated paste and similar materials. Without a moisture vapor venting system, however, product integrity will suffer in such non-enabled devices.

U.S. Pat. No. 5,190,213 discloses a reusable thermally insulated food delivery box for hot or cold food delivery which is made of corrugated plastic board having sealed fluted edges and creased on indented unperforated scored fold lines between adjacent panels. An example of a pizza box is shown manufactured from COR-X brand of corrugated plastic material available from Primex Corporation, with sealed fluted edges for sanitizing purposes. However, while insulation may be effective, sealing in moisture will also be achieved to degrade the product.

Yet another pizza packaging system is disclosed in U.S. Pat. No. 5,180,075 which employs paper bags and flat paperboard trays said to provide for pizza delivery in a warm, unsoggy condition. In use, a hot, freshly prepared pizza is positioned on a paperboard tray which is then covered or “bagged” by slipping on a moisture-permeable bag, all of which is then inserted in a reusable insulating outer box. Upon delivery, the bagged pizza arrangement is removed for pizza consumption and the outer box retained for future use. While, the outer box may also have a ventilation outlet, it is not described or known what type of moisture-permeable bags are useful in this product.

Further, U.S. Pat. No. 4,217,069 discloses a hot food carton having an insulated bottom wall structure, comprising a plurality of layers enclosing a plurality of void spaces which are said to limit the conduction of heat from hot foods positioned on an upper surface to a cold surface on which the bottom of the carton lays. The void spaces are conical dimples depressed into lower layers of a bottom wall, or elongated v-shaped grooves or furrows.

Another take-out food container is shown in U.S. Pat. No. 4,206,845, which is provided with a resilient lip structure which, when interlocked with a cover portion, forms vents which are said to provide air circulation in the closed container to prevent condensation.

U.S. Pat. No. 4,237,171 also describes an insulated and moisture absorbent food container, which is provided with an inner layer of absorbent paperboard adhered to an outer layer of resinous foam insulating material. The inner layer made of paperboard is said to have an absorbent porous structure, but yet be of sufficient thickness and rigidity to form a container body, such as that of the familiar-shaped pizza box. There are also provided a series of cut-out vent holes along a rear portion of the container, but are said to be only needed, assuming to release moisture vapor, under extreme circumstances.

Still another disposable food container is shown in U.S. Pat. No. 4,144,968 which comprises a pair of rim container elements, each of which has a central substantially planer section and a rim element which extends around the planer section in a substantially closed contour manner. The rim elements also have a pair of upper and lower cooperating elements for nesting interface of one of the upper cooperating elements of one of the container elements with the lower cooperating element of a next successive one of the container elements. Each of the upper and lower cooperating elements also has at least one aperture formed therethrough and which are alignable for permitting the exit of gaseous products when the upper and lower cooperating elements of the pair of container elements are in a nesting interface relation.

While no doubt all of such above-described examples of conventional food containers have some desirable features, no one can seriously argue that takeout or delivery food products still more often than not arrive as a soggy tasteless mess where once a quality food product existed. There therefore still exists an important and unmet need for relatively inexpensive, and preferably disposable and bio-degradable or easily recyclable, food delivery container products which preserve the quality integrity of food products substantially as freshly prepared, and which do not contribute to their self-destruction by reflecting, condensing or refluxing moisture vapor, but yet allow for efficient venting of moisture and/or air circulation while still preserving a substantial amount of original temperature as prepared.

### SUMMARY OF THE INVENTION

In accordance with long felt needs for an improved food container to overcome the failings and drawbacks of conventional containers, the present invention provides a novel and greatly improved food container which allows for the delivery of hot and chilled food substantially as originally prepared, even after a substantial time lapse, such as an hour or more. The novel inventive containers comprise the shapes and many, or all, of the features of familiar-shaped food take-out, fast-food and delivery containers, but are fabricated of layers of cardboard, or other conventional synthetic food container construction material which forms a sandwich around, or about, an insulating material, such as a metallic insulating material, for instance aluminum foil, or more preferably a corrugated arrangement with a sandwiched middle insulation layer preferably facing a food product. The inventive containers further optionally comprise a plurality of tiny vent holes or convection holes or vents, such as pin sized holes about the sides and/or top, or in some embodiments the bottom of the container, to allow for release of entrapped moisture vapor emanating from a hot food product within. Convection currents across the top or side portions of the container will serve to draw moisture vapor from the container by way of the plurality of convection vent holes, with condensation forming within the plurality of tiny vent holes where such condensation will remain substantially entrapped by capillary action without dropping back on the food product to promote unwanted reflux action. This arrangement provides for a thermally insulated food product substantially as originally prepared and in a non-soggy state. Pizza and burgers will be delivered firm and tasteful, and even french fries will not suffer from light or even extended travel times.

The invention is more fully described with reference to the following Detailed Discussion of Preferred Embodiments with reference to the drawings and appended claims.

### BRIEF DESCRIPTION OF THE DRAWINGS

FIG. 1 illustrates in perspective, elevational view, an embodiment of a food product container of the invention, having a lid in an open position and depicting an example food product.

FIGS. 2-3 illustrate alternative embodiments of unfolded or unassembled food containers of the invention in perspective, elevational views for use with a variety of contained food products.

FIG. 4 are exploded cross-sectional views illustrating preferred embodiments of a composite sandwiched ply construction material of the food product containers of the present invention.

FIG. 5 are exploded cross-sectional views which illustrate other preferred embodiments of mettalo-paper composite construction materials for use with the food products of the present invention.

FIGS. 6 and 7 are prospective elevational view of products of the invention having a plurality of appropriately-sized vent holes.

FIG. 8 is a perspective elevational view of yet another of a preferred embodiment of a food container product for use with different types of food products.

FIG. 9 is yet another perspective elevational view of a preferred embodiment of a food container product of the invention illustrating foldable cover portions.

### Brief Discussion of Preferred Embodiments

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

Having now prefaced this discussion, the present invention provides for improved food containers to overcome the failings and drawbacks of conventional containers. The present invention provides novel and greatly improved food containers which allow for the delivery of hot and chilled food substantially as originally prepared, even after a substantial time lapse, such as an hour or more. These inventive containers comprise the shapes and many, or all, of the features of familiar-shaped fast-food, take-out and food delivery containers, but are fabricated of layers of cardboard, or other conventional synthetic food container construction material, which form a sandwich around, or about, a core insulating material, preferably such as in corrugated construction fashion. The containers further preferably comprise a plurality of tiny vent holes, such as pin sized holes, about the sides and/or top, or in some embodiments the bottom of the container, to allow for release of entrapped moisture vapor emanating from a hot food product within by way of convection currents across the top, side or bottom portions of the container. Such vent holes serve to draw moisture vapor from the container with condensation forming within the plurality of tiny vent holes, which is substantially entrapped and held within the vent holes or spaces by capillary action, and substantially not on the food product, to provide for a thermally insulated food product substantially as originally prepared and in a non-soggy state.

The materials of construction of the inventive food containers, preferably used for carry-out, take-out or delivery foods, such as typical fast food, pizza, calzones, hamburgers, french fries and other food products, preferably comprise a metal insulation layer, such as aluminum sandwiched between or incorporated within, layers of paper, such as cardboard, or corrugated cardboard or other wood or fabric fiber-derived products or composites. Plastics and plastic fiber-paper composites are also contemplated. Although aluminum is preferred as a sandwiched middle layer for its excellent thermal insulation properties, any other material, preferably non-toxic and suitable for insulation of food products, such as metalized plastic material encompassing air-filled voids, plastic insulation and the like may also be used.

In preferred embodiments, corrugated cardboard is employed because of its ease of fabrication inclusive of a middle insulating layer, such as aluminum, and its structural integrity in remaining in an intended shape to protect food products within, such as a pizza box or other food containers, which oftentimes are subjected to harsh treatment during stacking, shipment and storage.

As is known, corrugated cardboard has a corrugated (wavy) inside layer, also known as a “flute,” sandwiched between layers of linerboard or other layers of paper, and is widely employed to make containers for shipping products to factories, warehouses, retail stores, offices and homes, in addition to use as food containers. It is often preferred for use as it is light, durable, strong and easily custom-sized for a particular product. It is also an excellent material for recycling, which can be used to make new containers, gift wrap, boxboard cartons, roofing felt, flower pots and other bio-degradable gardening supplies.

By “corrugated” cardboard or other material as used herein, reference is made to different geometric shapes of flute material, of which at least one side thereof, preferably the side facing an enclosed food product, is provided with an integral or attached insulating material, such as aluminum foil, and which material is sandwiched between layers of “linerboard”, or top and bottom sheets of the material. The inside or sandwiched flute material, inclusive of the integral or attached insulating material, may be of any repeating geometric shape covering the entire area of top and bottom linerboards to provide for any type of surface area coverage. As shown in Example 1 below, all of the various possible flute configurations Nos. 1-7, of which these are merely an exemplary partial list, having different surface areas are contemplated for use in this invention:

### EXAMPLE 1

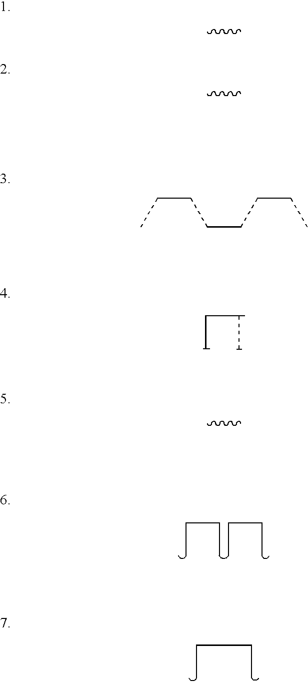

As also shown in this example, calculations of different surface areas are well known, as one may conveniently track or categorize a desired efficient surface area of insulation with a particular food product enclosed, and/or of a particular sized product and the like for the production and availability of customized food containers, if so desired, depending on such factors as delivery time or expected travel time and the like. Customized container strength may also be calculated and employed as desired using different geometric flute configurations for desired resulting rigidity or flexural stiffness, such as for delicate entrees, as opposed to pizza.

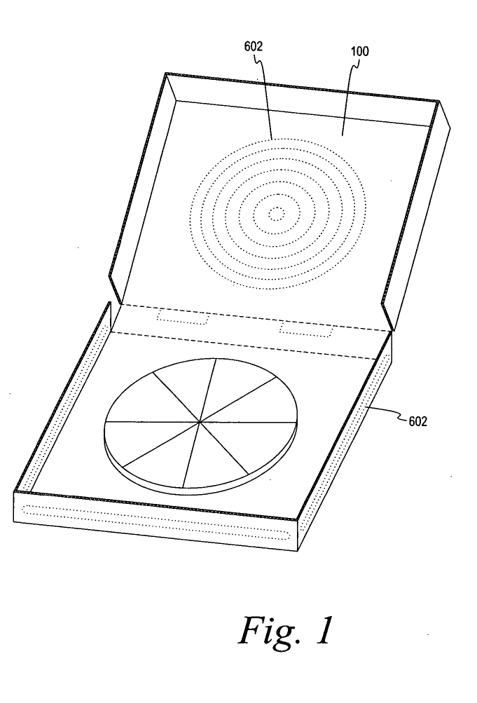

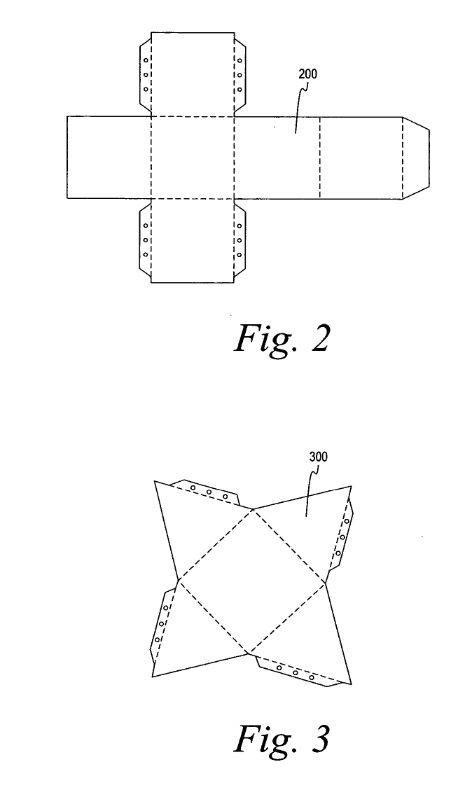

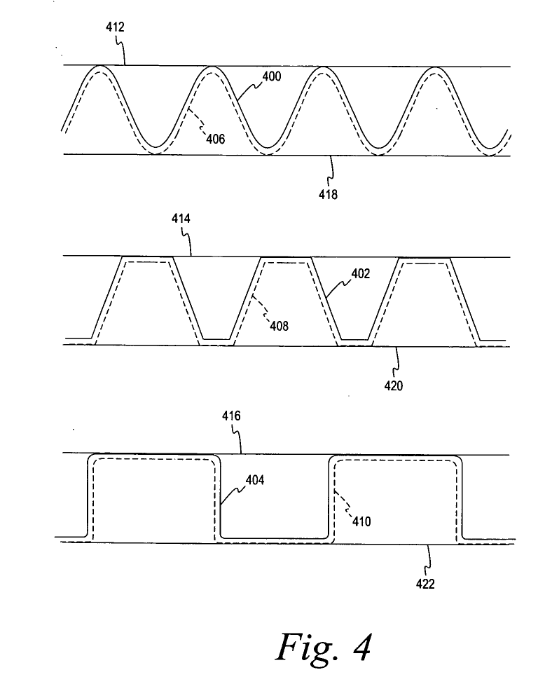

A typical pizza delivery box configuration (100) for use with the present invention is shown in FIG. 1. Other unassembled or non-folded pizza or food transport or deliverable containers for use with the invention are shown, respectively, in FIGS. 2-3 (200) (300). As shown in FIG. 4, each of the different geometric repeating flute shapes (400), (402) and (403) respectively, in this non-exhaustive example has attached or integral to a side, preferably a side which will face an enclosed food product, a suitable insulation material (406), (408) and (410), such as aluminum foil or metalized polymer material, such as, including, without limitation, metalized polyethylene sheet or other metalized synthetic sheet material, for instance, metalized orientated polyethylene, metalized polypropylene and metalized polyester. The insulation material is not required to be placed on a side facing an enclosed food product, but such insulating material may be present on both sides of a flute, or present on a side not facing an enclosed food product as desired. In these examples upper liners or linerboards (412), (414) and (416) and bottom liners or linerboards (418), (420) and (422) enclose top and bottom portions of flutes (400), (402) and (404), respectively, to form corrugated materials. The insulated flute arrangements are referred to herein as the “hybrid” food containers of the invention. In further preferred embodiments, when a corrugated material is not employed for a container construction, a sandwiched layer may comprise insulating material on one or both sides of the layer opposite each other.

The hybrid insulated corrugated food containers can be customized to accommodate essentially any size and configuration of food product, and may also, as described above, be custom engineered by way of geometric corrugated flute configurations to provide for maximum strength and quality, or a desired flexural stiffness of selected hybrid corrugated structures along with the desired insulation and moisture venting properties as contemplated for particular food products.

As known, top-to-bottom compression strength of a corrugated container is in part dependant on the load-carrying ability of central panel or flute areas. The ability of such central panel areas to resist a bending or other deforming force from loading will serve to increase the stacking strength of a container. Thus, different compression strengths of containers of identical dimensions, fabricated from identical components, but with different flute types or inner layer configuration, are caused for the most part by flexural stiffness of the container panels or portions. In selecting a particular corrugated configuration for a particular transported food, top-to-bottom compression strengths of containers as desired can be accurately predicted by flexural stiffness measurements by an edge crush test (ECT) of the combined container portions. See, for example, Lee et al., Packaging, Technology and Science, Volume 17, No. 5, pp. 275-286 (12), September 2004 (John Wiley & Sons, Ltd.).

Additional variables which may be considered in selecting and/or designing a particular hybrid corrugated configuration with desired flexural stiffness for use as an inventive food container include, in addition to flute type and size, paper weights, adhesive types, the type of insulating material employed and its thickness, and treatments and coatings, as corrugated stock is routinely custom designed to meet specific customer requirements. This invention contemplates all of such considerations.

Additionally, paper-based corrugated materials have a well known reputation for their natural, environmentally-friendly nature and ease of recycling and recovery. Generally, corrugated paper-based materials are made from papers which are made up from cellulose fibers, of which some are virgin, but in recent times are obtained from mostly recycled fibers. They are traditionally manufactured from a combination of two sheets of paper, called liners, which are glued to a corrugated inner medium or fluting or fluted midsection.

In the present invention, in one example, a liner with an attached single-face flute may then have applied to it a layer of aluminum foil or other type of insulative material, either to one side or to the opposite side or to both sides thereof, such as aluminum foil or metalized polyethylene and the like as described above and as shown below in Example 2. A second liner is then attached with adhesive.

### EXAMPLE 2

[image]

As can be seen in Example 2, this type of construction of a series of connected arches, or other type of flute configuration as desired, provides the ability to support strong weights, and comprises considerable rigidity and resistance. As an added benefit, air circulating within the flute structure also serves as an insulator, in addition to the aluminum sheet or other applied insulation, thereby providing excellent protection against temperature variations and to ensure product quality preservation. Some of the many other attributes of corrugated construction of food containers are crush-resistance, tear, tensile and burst strength, impact, drop and vibration damage resistance, in addition to uniform stacking and weight distribution.

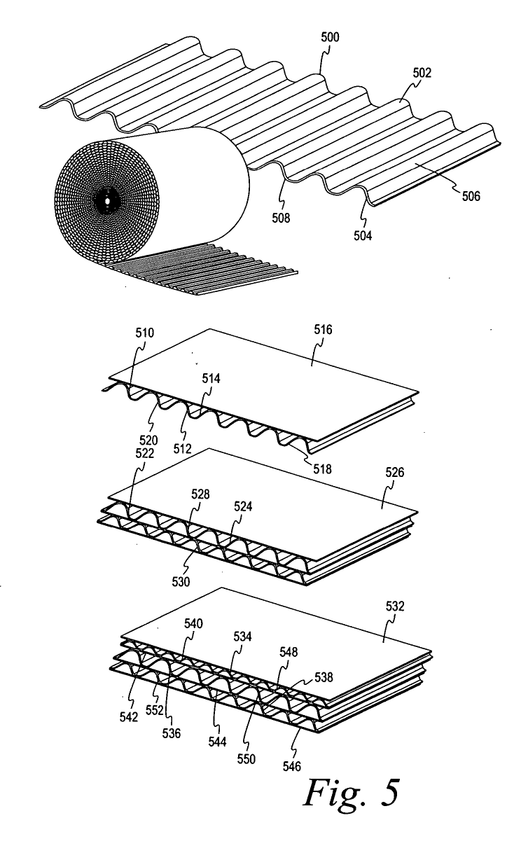

As also discussed above, depending upon the end use results contemplated, and the structural stiffness and rigidity desired, and also to a degree the extent of insulating qualities desired, many types of corrugated configurations with different flute sizes and profiles are available, and are contemplated for use in this invention. For example, as shown in FIG. 5, in addition to a single wall corrugated construction, twin and triple wall corrugated construction is also contemplated for use herein in the fabrication of food and transport containers.

Also contemplated for use with the present invention is any conventional manufacturing process for producing corrugated materials of container construction. In commercial production, flute sizes are usually standardized with some corrugated boards having a large number of very small standardized flute sizes, and some having small numbers of very large standardized flute sizes. There may also be corrugated structure arrangements of differing mixed or alternating sizes and/or geometric shapes of flutes present in differing amounts depending upon the particular properties desired. As mentioned above, the end use(s) contemplated, as well as several other considerations, will usually determine which flute style(s) are most desirable.

Using customary manufacturing vocabulary, a single liner glued to a corrugating medium creates a single face corrugated board, to which is attached to the flute an insulating material, such as a sheet aluminum foil, to either side, or both sides as desired. This type of material is oftentimes very flexible, and is used to cushion delicate items, such as light bulbs, and when combined in hybrid form with a suitable insulation material of the invention is ideal for transport and protection, and taste and quality preservation, of food products.

In other examples, such as shown in FIG. 5, corrugating medium (506) glued onto a single flat liner (508) forms a single-faced corrugated board (500). This form in which a flute material (502) is covered at least on one side with insulation material (504) is also contemplated for use herein.

In another example shown in FIG. 5, corrugating medium (510) is glued between two flat liners (512) and 514) to form a single-wall corrugated board (516), and in which the flute material (518) is covered at least on one side with insulation material (520).

The addition of yet another corrugating medium (522) and a third flat liner (524) will create a double wall corrugated board (526), which is stronger than a single wall board. This type of construction, as also shown in FIG. 5, is contemplated for use herein with at least one, and perhaps more than one as desired, corrugating medium (flute) sides having applied thereto an insulating material (528) (530) to produce a hybrid construction material of the invention.

As further shown in FIG. 5, there are also triple wall corrugated boards (532), having three layers of corrugating medium (534), (536) and (538) and four flat liners (540), (542), (544) and (546), which are also contemplated for use herein. In this mode of construction, one or more corrugation mediums, on at least one side thereof, may have applied thereto an insulating material (548), (550) and (552) for use in container construction of the invention.

In production, the corrugating medium, which becomes the middle layer in a typical three-layer corrugated board sandwich, is usually pre-heated and steamed to soften its natural fibers of construction, which enable the formation of flutes. Next, a web, or long sheet of paper unwinding from a roll is drawn between a pair of gear-like cylinders called corrugating rolls, which shapes the paper into a series of symmetrical waves. Prior to this step, the paper coming off the roll may have insulation material applied to it, again, on either or both sides, such as thin sheet aluminum foil, to produce a hybrid fluted corrugating medium of the invention. The aluminum foil or other insulation material may be glued to the paper linerboard or attached in any suitable way. In other embodiments the fluted material may itself be an insulation medium made of foil or some other composite insulating material, such as metalized plastic. In a next step, glue is applied to the tips of these flutes on one side, and the flute tips pressed against a flat liner to create a single face web, or a continuous sheet of flat paper with hybrid fluted-insulation paper glued to it. To continue the process to make a single wall corrugated board, the exposed flutes of the single face web have glue applied thereto, and they are pressed against a second flat liner. In further construction processes, other features of the corrugating line press creases into selected portions of the corrugated board, such that folding on these creases may be used to create a three-dimensional container for use with the present invention. Machinery such as flexo-folder gluers can print, crease, slot, trim, fold and glue a container so it can be shipped flat and then be easily formed by a customer, e.g., a fast-food take-out or pizza restaurant.

In a further preferred embodiment of the invention, a container is preferably provided with a plurality of relatively small venting holes within any portion of the container, such as portions of the top, sides and/or bottom, to allow air circulation and heated moisture vapor, i.e., humidity, to escape from the containerized space, which vapor is emanating from a heated food product within. These vent holes, or as used herein, “convection holes,” may be provided in construction material before construction of the hybrid corrugated material, or added after a hybrid corrugated material of construction is fabricated, or to a container after its production from the hybrid corrugated material. By “relatively small” is meant holes approximately the size of a pin point or larger, such as about 0.5 mm to about 1 cm or larger.

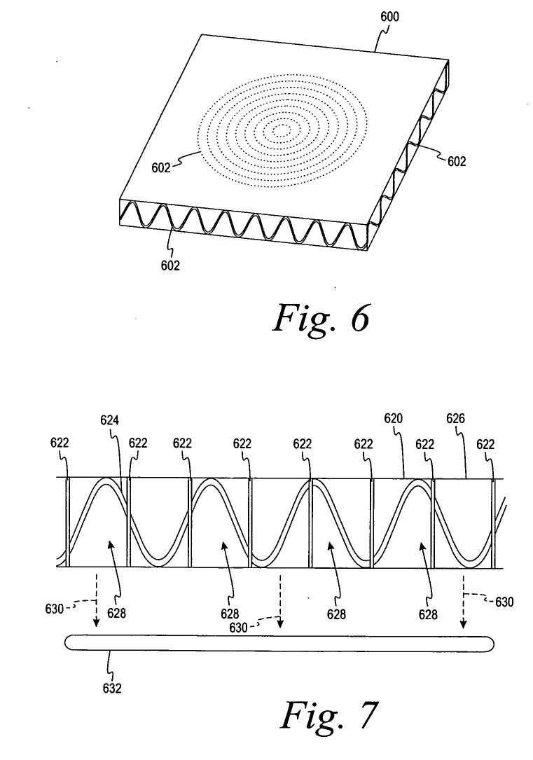

In a finished state, a container provided with a plurality of tiny venting or convection holes with a heated item within producing heated moist vapors will respond to outside convection currents of air flowing across the top, sides and/or bottom of the container to draw out the moist vapors. This activity serves to prevent condensation within, thereby keeping the food product warm or hot by way of hybrid corrugated insulation (or chilled), yet dry, or substantially in the state as freshly prepared by way of withdrawn moisture from convection or air circulation. Food container products of the invention (600) and (620), respectively provided with vent holes (602) and (622) as described are illustrated in perspective elevational views in FIGS. 6 and 7. As also shown in FIG. 7, a corrugating medium or a series of flutes (624), is attached to two flat liners (626) and (628), through which vent holes (622) traverse, as well as portions of the flute material (624). As additionally shown, moisture may collect within the areas (628) about the flute structure (624), where it may condense to thereby assist or at least prevent in part condensed water droplets shown as dotted lines falling back upon an enclosed food product (632).

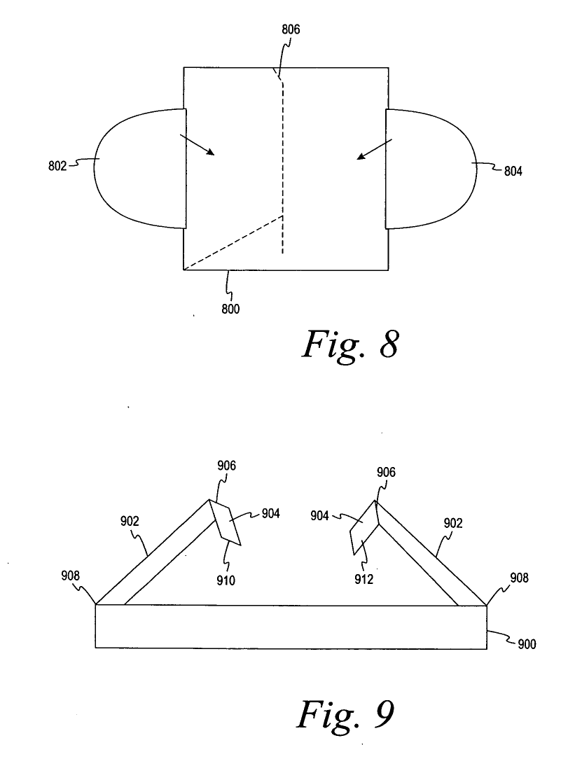

Additional elevational perspective views of food container products of the invention are shown in FIGS. 8 and 9. In FIG. 8, a preferred container of the invention (800), optionally provided with a plurality of venting holes as described above, may be compartmentalized, here shown as partitions (802) and (804), within the container (800) as shown by an installed position (806) by way of dotted lines, for example, to contain a portion of pizza with a certain topping and on another side another portion of pizza with a different topping. Containers may also be provided with one partition containing a liquid food product, such as a soup or stew, or a chili product and the like, with one or more compartmentalized partitions containing a substantially solid food product, such as a sandwich. A container with any number of such food-containing compartments or partitions may be employed as desired. Additionally, containers with different compartments or partitions for different forms of prepared foods may be equipped with different heated moisture venting properties by way of the number and geometry of venting holes provided depending upon the nature of contained food products.

As shown in FIG. 9, there is yet another perspective elevational depiction of a preferred food product container of the invention equipped with folding wings (901) which fold up and down from their respective base attachments by way of a provided crease in each and which are effective to form a hinge means (908) with their outer edges (904) comprising a longitudinal portion of each folding wing (904) which is folded down throughout its longitudinal dimension, e.g., by way of a crease and the like (906), to form respective edges (910) (912) which may become frictionally engaged with each other to form a convenient cover enclosing a container food product, such as a pizza box or hamburger or sandwich container and the like.

The size of the convection holes preferably are not of a size such that an appreciable amount of heat may escape, but are preferably of a size effective to substantially maintain a desired food product temperature in the container, but yet allow an effective amount of moisture vapor to escape or vent, such that a contained food product is maintained reasonably dry, or in a state substantially as freshly prepared and packaged. As a non-limiting example, a plurality of convection holes each approximately 0.5 mm to about 1 cm in diameter or larger may be employed running in uniform fashion the entire width of a corrugated board construction, from one liner through a portion of the fluted structure through another liner.

The shape of the venting holes may also be designed to maximize venting of heated moist vapors while retaining a desired heated temperature. One preferred geometric shape of a convection hole may be of substantial frusto-conical configuration with its widest side preferably facing an enclosed food product. In this embodiment, the wide open side facing a heated enclosed food product is better able to collect heated vapor moisture, with its expulsion from the container accelerated by compression of the collected moisture vapor in the restricted space of the small opposite end of the frusto-conical shape while preserving heat within the container.

As a further advantage, without intending to limit this invention to any particular theory, it is thought that humidity escaping the container via the inventive convection holes may result in condensation within one or more holes or within the inside portion of corrugated middle portion, and which is entrapped or held within such locals by way of capillary action to keep condensation, i.e., water droplets, from dropping back on a food product, or from forming on the surface of a contained food product.

As further contemplated in this invention, materials of construction of the inventive products, including corrugated products, may be from any sort of paper product, treated paper product, composite paper/plastic fiber product, or of any type of material suitable for use with food products.

In another aspect of the invention, there are provided novel methods of conducting one or more business functions comprising the design, production, marketing, distribution, sale, licensing and/or leasing of the subject matter involving the inventive food containers. The novel containers and methods of their production and use provide unique business opportunities heretofore unavailable, and which will enable the capture of a distinct and exclusive market share for its owners and licensees in the important food services sector with the invention's advantages over conventional methodology as described. It is further contemplated that the inventive subject matter herein be employed as a valuable business tool in the generation of business goodwill and as a vehicle for use in conjunction with trademarks to generate valuable source identifiers, and as subject matter to form and operate a business entity.

It is to be understood that many modifications and variations besides those preferred embodiments described above may be made in the food containers of the invention without departing from the scope and spirit of invention and claims. It is also to be understood that the above embodiments are for illustrative purposes only and are not intended to limit the invention and/or the scope of the appended claims in any way.

We claim:

1. A food container product comprising top, sides and bottom portions, and wherein at least said top portion comprises a layer of insulation material sandwiched between layers of container construction material.

2. The food container of claim 1 wherein said container construction material is corrugated paper, and in which the middle layer flute section has a layer of insulation material applied to at least one side.

3. The food container of claim 2 wherein said insulation material is selected from aluminum foil and metalized plastic sheet.

4. The food container of claim 3 wherein said container is one selected from a pizza delivery box, a sandwich delivery box, a hot entree delivery box.

5. A method for the production of the food container of claim 1.

6. A method for the production of the food container of claim 2.

7. A method for the production of the food container of claim 3.

8. A method for the production of the food container of claim 4.

9. A food delivery, take-out and/or fast-food service employing the use of the food container of claim 1.

10. A food delivery, take-out and/or fast-food service employing the use of the food container of claim 2.

11. A food delivery, take-out and/or fast-food service employing the use of the food container of claim 3.

12. A food delivery, take-out and/or fast-food service employing the use of the food container of claim 4.

13. A method of conducting business selected from designing, manufacturing, marketing, selling and licensing, developing business good will, developing trademark rights and forming and operating a business entity comprising the use of the food container product of claim 1.

14. A method of conducting business selected from designing, manufacturing, marketing, selling and licensing, developing business good will, developing trademark rights and forming and operating a business entity comprising the use of the food container product of claim 2.

15. A method of conducting business selected from designing, manufacturing, marketing, selling and licensing, developing business good will, developing trademark rights and forming and operating a business entity comprising the use of the food container product of claim 3.

16. A method of conducting business selected from designing, manufacturing, marketing, selling and licensing, developing business good will, developing trademark rights and forming and operating a business entity comprising the use of the food container product of claim 4.
